(19) United States
(12) Patent Application Publication
(10) Pub. No.: US 2026/0160891 A1
(43) Pub. Date: Jun. 11, 2026

(54) VEHICLE CONTROL DEVICE, VEHICLE CONTROL METHOD, AND STORAGE MEDIUM

(71) Applicant: TOYOTA JIDOSHA KABUSHIKI KAISHA, Toyota-shi (JP)

(72) Inventor: Tadashi OKUBO, Tokyo (JP)

(73) Assignee: TOYOTA JIDOSHA KABUSHIKI KAISHA, Toyota-shi (JP)

(21) Appl. No.: 19/379,764

(22) Filed: Nov. 5, 2025

(30) Foreign Application Priority Data
Dec. 5, 2024 (JP) 2024-212439

(51) Int. Cl. G01S 17/931; B60W 60/00; G01B 11/06

(52) U.S. Cl. CPC G01S 17/931; B60W 60/001; G01B 11/0608; B60W 2420/408; B60W 2520/10; B60W 2720/10

(57) ABSTRACT

A vehicle control device that executes autonomous driving of a vehicle based on a detection result of a LiDAR, calculates a road surface equivalent height that is equivalent to a height of a road surface on which the vehicle is traveling, based on a reflection point detected by the LiDAR, calculates the number of road surface equivalent height reflection points that are reflection points positioned at heights within a predetermined range from the road surface equivalent height, calculates a reflection point low density section that is a section where a density of the road surface equivalent height reflection points is less than a value that is predetermined, calculates a shortest distance between the reflection point low density section and the vehicle on a target traveling track of the vehicle as a detection limit distance, and decides an upper limit vehicle speed of the vehicle based on the detection limit distance.

### CROSS-REFERENCE TO RELATED APPLICATION

This application claims priority to Japanese Patent Application No. 2024-212439 filed on December 5, 2024. The disclosure of the above-identified application, including the specification, drawings, and claims, is incorporated by reference herein in its entirety.

### BACKGROUND

### 1. Technical Field

The present disclosure relates to a vehicle control device, a vehicle control method, and a storage medium.

### 2. Description of Related Art

Japanese Unexamined Patent Application Publication No. 2022-146522 (JP 2022-146522 A) discloses a vehicle control device that executes autonomous driving. In a technique described in JP 2022-146522 A, whether a detection capability of a peripheral monitoring sensor is equal to or less than a request level that is predetermined within a prediction time is determined based on dynamic map data.

### SUMMARY

In the technique described in JP 2022-146522 A, map data is used to execute autonomous driving of a vehicle, but, for example, in a mine in which the terrain frequently changes, the map data cannot be used to execute the autonomous driving of the vehicle. In addition, in the mine or the like in which the external environment of the vehicle is always changed, since a landmark that is commonly used to monitor a state of the peripheral monitoring sensor mounted on the vehicle is not present, the state of the peripheral monitoring sensor cannot be monitored using the landmark. In general, in a case where the vehicle is in a disturbance environment, such as rain or fog that causes a deterioration of a detection performance of the peripheral monitoring sensor, the vehicle is determined to be outside the operational design domain (ODD), the driving authority is delegated from a system to a person (driver), and the vehicle is stopped from traveling by the system. In a case where an autonomous driving system is applied to an unmanned running service, when the autonomous driving system frequently stops the unmanned running due to a determination that the vehicle is in the bad environment, an operation rate of the unmanned running service is decreased. A technique capable of suppressing the decrease in the operation rate of the autonomous driving in the environment, such as the mine, is desired.

In view of the circumstances, an object of the present disclosure is to provide a vehicle control device, a vehicle control method, and a storage medium capable of suppressing the decrease in the operation rate of the autonomous driving even in the environment, such as the mine.

An aspect of the present disclosure is a vehicle control device that executes autonomous driving of a vehicle based on a detection result of a LiDAR mounted on the vehicle, and the vehicle control device includes a road surface equivalent height calculation unit configured to calculate a road surface equivalent height that is equivalent to a height of a road surface on which the vehicle is traveling, based on a reflection point detected by the LiDAR, a reflection point number calculation unit configured to calculate the number of road surface equivalent height reflection points that are reflection points positioned at heights within a predetermined range from the road surface equivalent height, a reflection point low density section calculation unit configured to calculate a reflection point low density section that is a section where a density of the road surface equivalent height reflection points is less than a value that is predetermined, a road surface detection limit distance calculation unit configured to calculate a shortest distance between the reflection point low density section and the vehicle on a target traveling track of the vehicle as a detection limit distance, and an upper limit vehicle speed decision unit configured to decide an upper limit vehicle speed of the vehicle based on the detection limit distance.

In the vehicle control device of the present disclosure, the reflection point number calculation unit may be configured to calculate a reflection point number theoretical value that is the number of reflection points positioned at the heights within the predetermined range from the road surface equivalent height in a case where the road surface on which the vehicle is traveling is present at a position of the road surface equivalent height, and the reflection point low density section calculation unit may be configured to determine that the density of the road surface equivalent height reflection points is less than the value that is predetermined in a case where a ratio of the number of the road surface equivalent height reflection points to the reflection point number theoretical value is less than a ratio that is predetermined.

In the vehicle control device of the present disclosure, the reflection point low density section calculation unit may be configured to determine whether the ratio of the number of the road surface equivalent height reflection points to the reflection point number theoretical value is less than the ratio that is predetermined for each of a plurality of the sections having a grid shape defined in a plane coordinate system of the vehicle in a top view.

Another aspect of the present disclosure is a vehicle control method in which a vehicle control device executes autonomous driving of a vehicle based on a detection result of a LiDAR mounted on the vehicle, and the vehicle control method includes calculating, by the vehicle control device, a road surface equivalent height that is equivalent to a height of a road surface on which the vehicle is traveling, based on a reflection point detected by the LiDAR, calculating, by the vehicle control device, the number of road surface equivalent height reflection points that are reflection points positioned at heights within a predetermined range from the road surface equivalent height, calculating, by the vehicle control device, a reflection point low density section that is a section where a density of the road surface equivalent height reflection points is less than a value that is predetermined, calculating, by the vehicle control device, a shortest distance between the reflection point low density section and the vehicle on a target traveling track of the vehicle as a detection limit distance, and deciding, by the vehicle control device, an upper limit vehicle speed of the vehicle based on the detection limit distance.

Still another aspect of the present disclosure is a storage medium storing a program causing a processor that executes autonomous driving of a vehicle based on a detection result of a LiDAR mounted on the vehicle to execute calculating a road surface equivalent height that is equivalent to a height of a road surface on which the vehicle is traveling, based on a reflection point detected by the LiDAR, calculating the number of road surface equivalent height reflection points that are reflection points positioned at heights within a predetermined range from the road surface equivalent height, calculating a reflection point low density section that is a section where a density of the road surface equivalent height reflection points is less than a value that is predetermined, calculating a shortest distance between the reflection point low density section and the vehicle on a target traveling track of the vehicle as a detection limit distance, and deciding an upper limit vehicle speed of the vehicle based on the detection limit distance.

According to the present disclosure, the decrease in the operation rate of the autonomous driving can be suppressed even in the environment, such as the mine.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of a vehicle 1 to which a vehicle control device 14 of a first embodiment is applied;

FIG. 2 is a diagram for describing an example of a target traveling track or the like of the vehicle 1; and

FIG. 3 is a flowchart for describing an example of processing executed by a processor 143 of the vehicle control device 14 of the first embodiment.

### DETAILED DESCRIPTION OF EMBODIMENTS

Hereinafter, embodiments of a vehicle control device, a vehicle control method, and a storage medium of the present disclosure will be described with reference to the drawings.

### First Embodiment

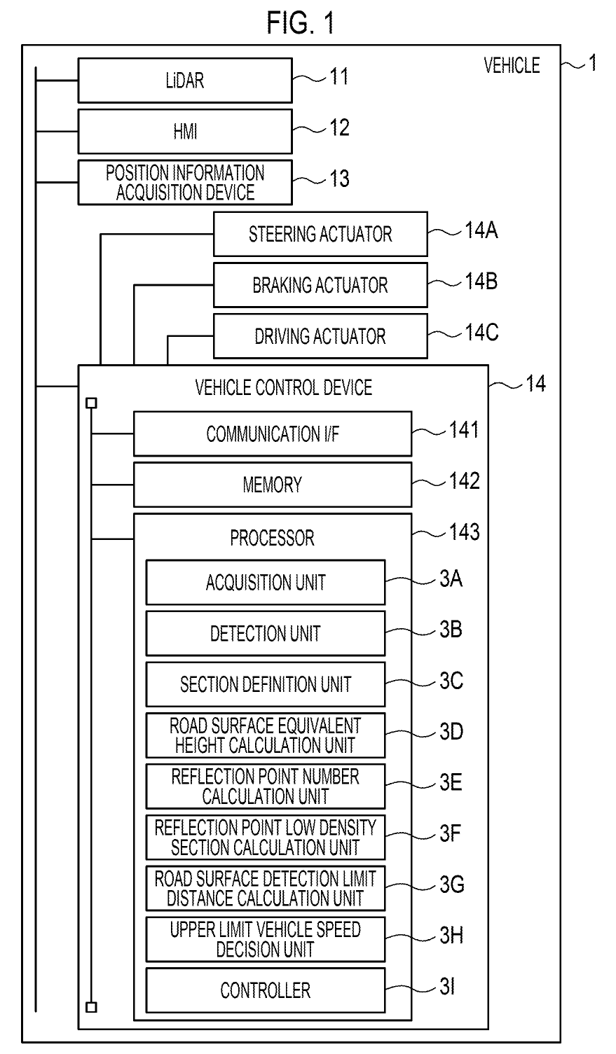

FIG. 1 is a diagram showing an example of a vehicle 1 to which a vehicle control device 14 of a first embodiment is applied.

In the example shown in FIG. 1, the vehicle 1 includes a light detection and ranging (LiDAR) 11, a human machine interface (HMI) 12, a position information acquisition device 13, the vehicle control device 14, a steering actuator 14A, a braking actuator 14B, and a driving actuator 14C.

The LiDAR 11 measures a reflection point that reflects the laser beam emitted from the LiDAR 11, a distance between the reflection point and the LiDAR 11, a direction of the reflection point, and the like. That is, the LiDAR 11 detects a reflection point that reflects the laser beam emitted from the LiDAR 11 and transmits a detection result (sensor data indicating a distance between the reflection point and the LiDAR 11, a direction of the reflection point, and the like) to the vehicle control device 14.

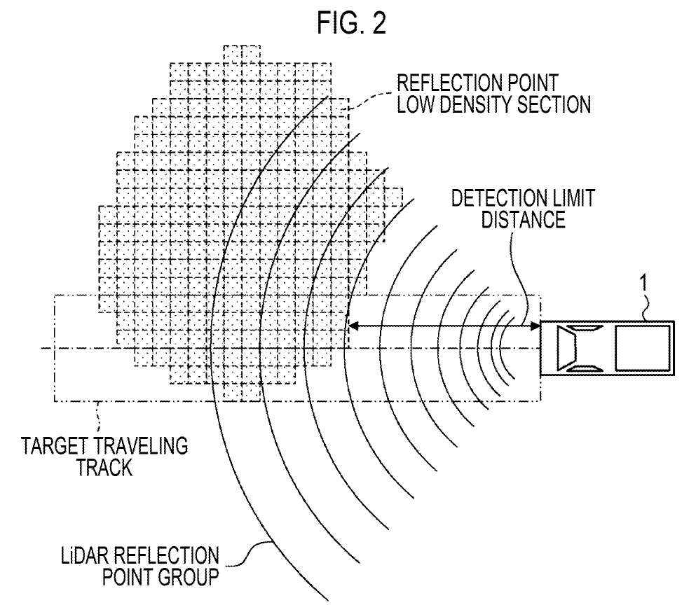

The HMI 12 has a function of receiving various operations of the user of the vehicle 1 (for example, an operation of inputting a target traveling track (see FIG. 2) of the vehicle 1) and the like, and transmits a signal indicating the operation of the user of the vehicle 1 to the vehicle control device 14.

FIG. 2 is a diagram for describing an example of the target traveling track or the like of the vehicle 1.

In the example shown in FIG. 2, a track on which the vehicle 1 travels by a distance that is predetermined in the left orientation (for example, the west orientation) in FIG. 2 is set as the target traveling track of the vehicle 1.

In the example shown in FIG. 1, the position information acquisition device 13 acquires information indicating a traveling position (for example, latitude, longitude, and azimuth (that is, position and orientation of the vehicle 1)) of the vehicle 1, and transmits the information indicating the traveling position of the vehicle 1 to the vehicle control device 14. The position information acquisition device 13 includes, for example, a global positioning system (GPS) sensor.

The vehicle control device 14 executes autonomous driving of the vehicle 1 based on the detection result of the LiDAR 11, information indicating the target traveling track of the vehicle 1, the traveling position of the vehicle 1 (latitude, longitude, azimuth (position and orientation of the vehicle 1), and the like). More specifically, the vehicle control device 14 controls the steering actuator 14A, the braking actuator 14B, and the driving actuator 14C. For example, in a case where an obstacle present on the target traveling track of the vehicle 1 is detected by the LiDAR 11, the vehicle control device 14 executes control for causing the vehicle 1 to avoid the obstacle. The vehicle control device 14 is configured by a microcomputer including a communication interface (I/F) 141, a memory 142, and a processor 143.

The communication interface 141 has an interface circuit for connecting the vehicle control device 14 to the LiDAR 11, the HMI 12, and the position information acquisition device 13. The memory 142 stores a program and various types of data used in processing executed by the processor 143.

The processor 143 has a function as an acquisition unit 3A, a function as a detection unit 3B, a function as a section definition unit 3C, and a function as a road surface equivalent height calculation unit 3D. The processor 143 further has a function as a reflection point number calculation unit 3E, a function as a reflection point low density section calculation unit 3F, a function as a road surface detection limit distance calculation unit 3G, a function as an upper limit vehicle speed decision unit 3H, and a function as a controller 3I.

The acquisition unit 3A acquires the detection result of the LiDAR 11 (sensor data indicating the distance between the reflection point and the LiDAR 11, the direction of the reflection point, and the like). In addition, the acquisition unit 3A acquires a signal (for example, a signal indicating the target traveling track of the vehicle 1) indicating an operation of the user of the vehicle 1 transmitted from the HMI 12. Further, the acquisition unit 3A acquires information indicating the traveling position of the vehicle 1 transmitted from the position information acquisition device 13.

The detection unit 3B detects the structure of the road surface on which the vehicle 1 is traveling and the obstacle on the road surface based on the detection result of the LiDAR 11. The section definition unit 3C defines a plurality of the sections having a grid shape in a plane coordinate system (that is, the plane coordinate system shown in FIG. 2) of the vehicle 1 in a top view. In the example shown in FIG. 2, each of the sections has a square shape (that is, two sides that are orthogonal to each other and that constitute the section have the same length), but in other examples, each of the sections may have a rectangular shape (that is, two sides that are orthogonal to each other and that constitute the section may have different lengths).

In the example shown in FIG. 1, the road surface equivalent height calculation unit 3D calculates a road surface equivalent height that is a height equivalent to the road surface on which the vehicle 1 is traveling, based on the reflection point detected by the LiDAR 11. Specifically, the road surface equivalent height calculation unit 3D calculates the average value of the heights of a plurality of the reflection points included in the predetermined range in the height direction among the reflection points (reflection points detected by the LiDAR 11) included in each of the sections defined by the section definition unit 3C, as the road surface equivalent height of the section. That is, the reflection point having the abnormal height is excluded, and the road surface equivalent height of the section is calculated.

In another example, the road surface equivalent height calculation unit 3D may calculate an average value of the heights of the reflection points included in each of the sections defined by the section definition unit 3C (that is, the average value including the reflection point having the abnormal height) as the road surface equivalent height of the section.

In the example shown in FIG. 1, the reflection point number calculation unit 3E calculates the number of road surface equivalent height reflection points that are reflection points positioned at the height within the predetermined range from the road surface equivalent height calculated by the road surface equivalent height calculation unit 3D. Further, the reflection point number calculation unit 3E calculates a reflection point number theoretical value that is the number of reflection points (virtual reflection points) positioned at a height within a predetermined range from the road surface equivalent height in a case where the road surface on which the vehicle 1 is traveling is present at the position of the road surface equivalent height.

In the example shown in FIG. 2, the road surface on which the vehicle 1 is traveling is not present at the position of the road surface equivalent height in the "reflection point low density section" among regions in which a LiDAR reflection point group is obtained. For example, the terrain is protruded or depressed with respect to the road surface equivalent height, an obstacle is present, and the like. On the other hand, in the section that is not the “reflection point low density section” in the region where the LiDAR reflection point group is obtained, the road surface on which the vehicle 1 is traveling is present at the position of the road surface equivalent height. That is, the vehicle 1 can travel through the sections. In the example shown in FIG. 1, in order to calculate the reflection point number theoretical value, the reflection point number calculation unit 3E uses, for example, the angle (beam angle) of the laser beam irradiated on each of the sections from the LiDAR 11, the distance between the LiDAR 11 and each of the sections, and the height of the virtual reflection point included in each of the sections. That is, the road surface equivalent height is used for the reflection point number calculation unit 3E to calculate the reflection point number theoretical value.

In another example, the reflection point number calculation unit 3E may calculate the reflection point number theoretical value by using parameters different from the parameters described above.

In the example shown in FIG. 1, the reflection point low density section calculation unit 3F calculates a reflection point low density section that is a section where the density of the road surface equivalent height reflection points is less than a value that is predetermined. Specifically, the reflection point low density section calculation unit 3F determines whether the ratio of the number of road surface equivalent height reflection points to the reflection point number theoretical value is less than a ratio that is predetermined for each of the sections defined by the section definition unit 3C.

The ratio of the number of road surface equivalent height reflection points to the reflection point number theoretical value may be less than the ratio that is predetermined. In this case, the reflection point low density section calculation unit 3F determines that the density of the road surface equivalent height reflection points in the section is less than a value that is predetermined. The reflection point low density section calculation unit 3F calculates the section as the reflection point low density section (section that is hatched in FIG. 2).

The ratio of the number of road surface equivalent height reflection points to the reflection point number theoretical value may be equal to or greater than the ratio that is predetermined. In this case, the reflection point low density section calculation unit 3F determines that the density of the road surface equivalent height reflection points in the section is equal to or greater than a value that is predetermined. Then, the reflection point low density section calculation unit 3F calculates the section as a section that is not the reflection point low density section (in the example shown in FIG. 2, the section corresponding to the section that is not hatched among the regions in which the LiDAR reflection point group is obtained).

The road surface detection limit distance calculation unit 3G calculates a shortest distance between the reflection point low density section (see FIG. 2) on the target traveling track (see FIG. 2) of the vehicle 1 and the vehicle 1 as a detection limit distance (see FIG. 2).

In the example shown in FIG. 2, the road surface detection limit distance calculation unit 3G calculates the distance between the vehicle 1 and each of three reflection point low density sections having the shortest distance from the vehicle 1 among 60 reflection point low density sections on the target traveling track of the vehicle 1 as the detection limit distance.

In the example shown in FIG. 1, the upper limit vehicle speed decision unit 3H decides an upper limit vehicle speed of the vehicle 1 based on the detection limit distance calculated by the road surface detection limit distance calculation unit 3G. Specifically, the upper limit vehicle speed decision unit 3H calculates a lower vehicle speed as the upper limit vehicle speed of the vehicle 1 as the detection limit distance calculated by the road surface detection limit distance calculation unit 3G is shorter.

The controller 3I executes the speed control of the vehicle 1 based on the upper limit vehicle speed decided by the upper limit vehicle speed decision unit 3H.

Therefore, in the example shown in FIG. 1, the vehicle control device 14 can execute control for safely stopping the vehicle 1 within the detection limit distance.

That is, in the example shown in FIG. 1, in a case where a protrusion, a depression, an obstacle, or the like, on which the vehicle 1 cannot travel, is present on the target traveling track of the vehicle 1, the autonomous driving of the vehicle 1 by the vehicle control device 14 is immediately stopped, and thus it is possible to suppress a possibility that the operation rate of the autonomous driving is decreased.

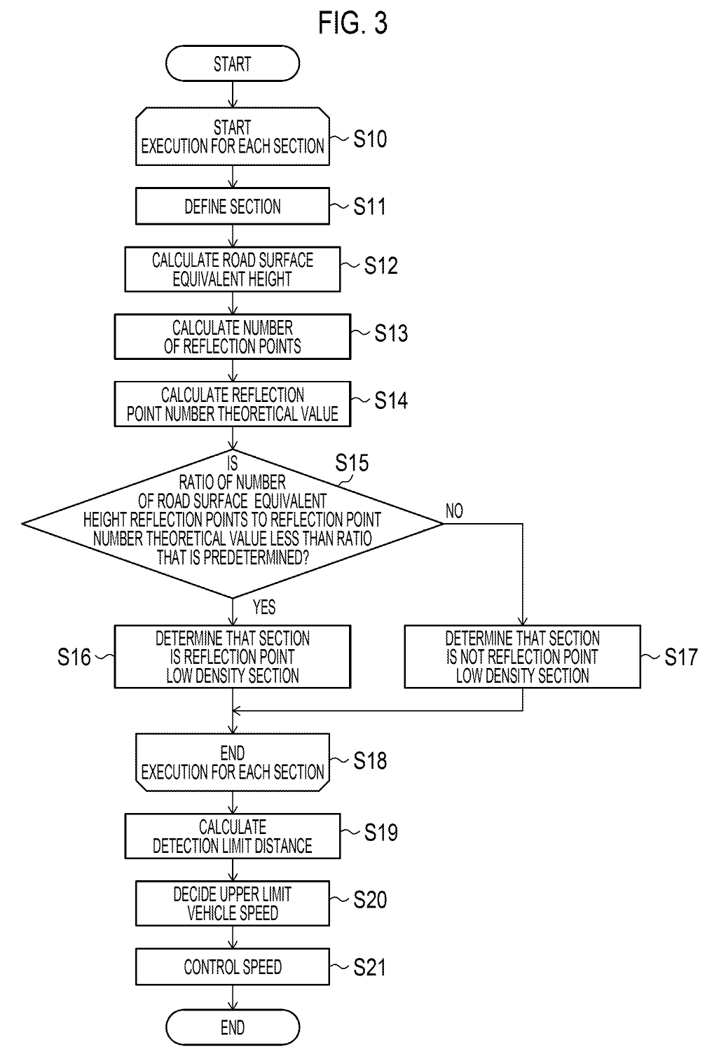

FIG. 3 is a flowchart for describing an example of processing executed by the processor 143 of the vehicle control device 14 of the first embodiment.

In the example shown in FIG. 3, in S10 to S18, the processing for each section is executed. Specifically, in S10, the execution of the processing for each section is started.

In S11, the section definition unit 3C defines the section in the plane coordinate system of the vehicle 1 in the top view.

In S12, the road surface equivalent height calculation unit 3D calculates the road surface equivalent height of the section defined in S11 based on the reflection points detected by the LiDAR 11 (the reflection points included in the section defined in S11).

In S13, the reflection point number calculation unit 3E calculates the number of reflection points that are the road surface equivalent height reflection points positioned at the height within the predetermined range from the road surface equivalent height (the road surface equivalent height calculated in S12) of the section defined in S11.

There is a case where the reflection point number calculation unit 3E determines that the road surface on which the vehicle 1 within the section defined in S11 is traveling is present at the position of the road surface equivalent height calculated in S12. In this case, in S14, the reflection point number theoretical value that is the number of reflection points positioned at the heights within the predetermined range from the road surface equivalent height (virtual reflection points included in the section defined in S11) is calculated.

In S15, the reflection point low density section calculation unit 3F determines whether the ratio of the number of road surface equivalent height reflection points to the reflection point number theoretical value is less than a ratio that is predetermined for the section defined in S11. When the ratio of the number of road surface equivalent height reflection points to the reflection point number theoretical value is less than a ratio that is predetermined, the process proceeds to S16. When the ratio of the number of road surface equivalent height reflection points to the reflection point number theoretical value is equal to or greater than a ratio that is predetermined, the process proceeds to S17.

In S16, the reflection point low density section calculation unit 3F determines that the section defined in S11 is the reflection point low density section.

In S17, the reflection point low density section calculation unit 3F determines that the section defined in S11 is not the reflection point low density section.

When the processing of S11 to S17 is ended for all the sections having the grid shape defined in the plane coordinate system of the vehicle 1 in the top view, in S18, the execution of the processing for each section is ended.

In S19, the road surface detection limit distance calculation unit 3G calculates the shortest distance between the reflection point low density section on the target traveling track of the vehicle 1 and the vehicle 1 as the detection limit distance.

In S20, the upper limit vehicle speed decision unit 3H decides the upper limit vehicle speed of the vehicle 1 based on the detection limit distance calculated in S19.

In S21, the controller 3I executes the speed control of the vehicle 1 based on the upper limit vehicle speed decided in S20.

As described above, in the vehicle 1 to which the vehicle control device 14 of the first embodiment is applied, the shortest distance between the reflection point low density section on the target traveling track of the vehicle 1 and the vehicle 1 are calculated as the detection limit distance, and the speed control of the vehicle 1 is executed based on the upper limit vehicle speed of the vehicle 1 decided based on the detection limit distance. Therefore, even in a case where the obstacle is present at a position farther than the detection limit distance from the vehicle 1, the vehicle control device 14 can continue the autonomous driving of the vehicle 1 while appropriately avoiding the collision or the like between the vehicle 1 and the obstacle when the distance between the vehicle 1 and the obstacle is less than the detection limit distance. As a result, in a case where the vehicle 1 to which the vehicle control device 14 of the first embodiment is applied is applied to the unmanned running service, the unmanned running service can be continued without stopping the unmanned running as much as possible.

### Second Embodiment

The vehicle 1 to which the vehicle control device 14 of a second embodiment is applied is configured in the same manner as the vehicle 1 to which the vehicle control device 14 of the first embodiment is applied, except for the following points.

As described above, in the example shown in FIG. 1, the road surface equivalent height calculation unit 3D calculates the average value of the heights of the reflection points included in each of the sections defined by the section definition unit 3C as the road surface equivalent height of the section.

On the other hand, in the example of the vehicle 1 to which the vehicle control device 14 of the second embodiment is applied, the road surface equivalent height calculation unit 3D calculates a value other than the average value, such as the median value or the mode, of the heights of the reflection points included in each of the sections defined by the section definition unit 3C as the road surface equivalent height of the section.

As described above, the embodiments of the vehicle control device, the vehicle control method, and the storage medium of the present disclosure have been described with reference to the drawings. However, the vehicle control device, the vehicle control method, and the storage medium according to the present disclosure are not limited to the embodiments, and can be appropriately changed within the scope without departing from the spirit of the present disclosure. The configuration of each of the examples of the embodiments may be appropriately combined. In each of the examples of the embodiments, the processing executed by the vehicle control device 14 has been described as software processing executed by executing a program. However, the processing executed by the vehicle control device 14 may be processing executed by hardware. Alternatively, the processing executed by the vehicle control device 14 may be processing in which both software and hardware are combined. The program (program for realizing the function of the processor 143 of the vehicle control device 14) stored in the memory 142 of the vehicle control device 14 may be recorded in a computer-readable storage medium, such as a semiconductor memory, a magnetic recording medium, or an optical recording medium, and provided, distributed, or the like.

What is claimed is:

1. A vehicle control device that executes autonomous driving of a vehicle based on a detection result of a LiDAR mounted on the vehicle, the vehicle control device comprising:
a road surface equivalent height calculation unit configured to calculate a road surface equivalent height that is equivalent to a height of a road surface on which the vehicle is traveling, based on a reflection point detected by the LiDAR;
a reflection point number calculation unit configured to calculate the number of road surface equivalent height reflection points that are reflection points positioned at heights within a predetermined range from the road surface equivalent height;
a reflection point low density section calculation unit configured to calculate a reflection point low density section that is a section where a density of the road surface equivalent height reflection points is less than a value that is predetermined;
a road surface detection limit distance calculation unit configured to calculate a shortest distance between the reflection point low density section and the vehicle on a target traveling track of the vehicle as a detection limit distance; and
an upper limit vehicle speed decision unit configured to decide an upper limit vehicle speed of the vehicle based on the detection limit distance.

2. The vehicle control device according to claim 1, wherein:
the reflection point number calculation unit is configured to calculate a reflection point number theoretical value that is the number of reflection points positioned at the heights within the predetermined range from the road surface equivalent height in a case where the road surface on which the vehicle is traveling is present at a position of the road surface equivalent height; and
the reflection point low density section calculation unit is configured to determine that the density of the road surface equivalent height reflection points is less than the value that is predetermined in a case where a ratio of the number of the road surface equivalent height reflection points to the reflection point number theoretical value is less than a ratio that is predetermined.

3. The vehicle control device according to claim 2, wherein the reflection point low density section calculation unit is configured to determine whether the ratio of the number of the road surface equivalent height reflection points to the reflection point number theoretical value is less than the ratio that is predetermined for each of a plurality of the sections having a grid shape defined in a plane coordinate system of the vehicle in a top view.

4. A vehicle control method in which a vehicle control device executes autonomous driving of a vehicle based on a detection result of a LiDAR mounted on the vehicle, the vehicle control method comprising:
calculating, by the vehicle control device, a road surface equivalent height that is equivalent to a height of a road surface on which the vehicle is traveling, based on a reflection point detected by the LiDAR;
calculating, by the vehicle control device, the number of road surface equivalent height reflection points that are reflection points positioned at heights within a predetermined range from the road surface equivalent height;
calculating, by the vehicle control device, a reflection point low density section that is a section where a density of the road surface equivalent height reflection points is less than a value that is predetermined;
calculating, by the vehicle control device, a shortest distance between the reflection point low density section and the vehicle on a target traveling track of the vehicle as a detection limit distance; and
deciding, by the vehicle control device, an upper limit vehicle speed of the vehicle based on the detection limit distance.

5. A non-transitory storage medium storing a program causing a processor that executes autonomous driving of a vehicle based on a detection result of a LiDAR mounted on the vehicle to execute:
calculating a road surface equivalent height that is equivalent to a height of a road surface on which the vehicle is traveling, based on a reflection point detected by the LiDAR;
calculating the number of road surface equivalent height reflection points that are reflection points positioned at heights within a predetermined range from the road surface equivalent height;
calculating a reflection point low density section that is a section where a density of the road surface equivalent height reflection points is less than a value that is predetermined;
calculating a shortest distance between the reflection point low density section and the vehicle on a target traveling track of the vehicle as a detection limit distance; and
deciding an upper limit vehicle speed of the vehicle based on the detection limit distance.
